(19) United States
(12) Patent Application Publication
(10) Pub. No.: US 2008/0105638 A1
(43) Pub. Date: May 8, 2008

(54) VEHICLE ENGINE REMOVAL SYSTEM

(75) Inventors: John F. Crawford, Apalachin, NY (US); John Ford, Binghampton, NY (US); Adam C. Hunt, Freeville, NY (US); Benjamin A. Sternberg, Binghampton, NY (US)

Correspondence Address: BURNS & LEVINSON, LLP, 125 SUMMER STREET, BOSTON, MA, 02110, US

(73) Assignee: LOCKHEED MARTIN CORPORATION, Bethesda, MD (US)

(21) Appl. No.: 11/936,196

(22) Filed: Nov. 7, 2007

Related U.S. Application Data
(60) Provisional application No. 60/857,603, filed on Nov. 8, 2006.

(51) Int. Cl. B66C 23/44

(52) U.S. Cl. 212/180

(57) ABSTRACT

An engine and transmission removal system which includes an engine mount, a hoist mount, an engine framework, a lift mechanism, and a manual actuator. The engine mount includes a structural element for attachment to a part, such as an engine a transmission or a battery, in a vehicle drive system and shaped to conform to a portion of the part and having an extension to provide an additional lifting point when removing or installing such part in a vehicle. These parts can be used in combination together, or in various combination of only some of these parts.

### CROSS REFERENCE TO RELATED APPLICATIONS

This application claims the benefit of provisional application Ser. No. 60/857,603 filed Nov. 8, 2006, and the entire content thereof is hereby incorporated by reference.

### STATEMENT REGARDING FEDERALLY SPONSORED RESEARCH OR DEVELOPMENT

This invention was made, at least partially, with U.S. Government support under Contract No. W56 HZV-05-9-0002.

### FIELD OF THE INVENTION

This invention relates generally to the vehicle art, and, more particularly to a system for rapidly removing and/or installing vehicle parts, such as engines, transmissions, batteries and the like.

### BACKGROUND OF THE INVENTION

U.S. Pat. No. 1,020,518 relates to the construction of vehicles in which the power plants are situated as to be easily removed for repair or the like.

U.S. Pat. No. 1,199,708 is for a demountable unit power plant for motor vehicles.

U.S. Pat. No. 1,635,388 discloses a motor vehicle in which the power plant is removably supported on the chassis.

U.S. Pat. No. 1,648,875 discloses an engine and generator mounted in a frame thereby creating a unitary assembly which can be removed as a unit from the main vehicle frame. A motor is supported on a frame that is on tracks that are mounted on a main frame.

U.S. Pat. No. 1,697,565 discloses a replacement engine device arranged to be interchangeable to be transferred from one machine to another.

U.S. Pat. No. 1,738,532 discloses an engine mounting for providing a resilient mounting that is intended to insulate the engine and frame from each other.

U.S. Pat. No. 1,863,370 discloses a resilient connection for connecting two metal members.

U.S. Pat. No. 1,893,609 discloses a demountable motor construction for automobiles in which the engine can be rolled into or out of position.

U.S. Pat. No. 1,900,773 discloses a motor vehicle in which the motor is mounted on a sub-frame so that it can be moved out of normal position into a position for allowing inspection thereof.

U.S. Pat. No. 2,028,549 discloses a mounting for devices such as an automobile engine and is concerned with vibrations.

U.S. Pat. No. 2,095,058 discloses a motorized vehicle cab where it is possible to demount the prime mover for making major repairs.

U.S. Pat. No. 2,209,001 discloses parallel track elements mounted on opposite sides of an engine and secured to the chassis frame of an automobile. Carriages allow the motor to roll on the track elements.

U.S. Pat. No. 2,215,117 discloses an arrangement or adjustably mounting an engine.

U.S. Pat. No. 2,224,562 discloses a motor vehicle having an engine and water circulating system which can be mounted or dismounted as a single unit with respect to the motor vehicle frame.

U.S. Pat. No. 2,395,769 discloses a power plant mounted on auxiliary frame structure having side members, a cross member and a rigid front cross member.

U.S. Pat. No. 2,468,671 discloses a yielding motor mounting.

U.S. Pat. No. 2,720,931 discloses an engine mounting for a cab type vehicle in which the engine is behind the cab seat.

U.S. Pat. No. 3,132,830 discloses a resilient mounting for motor vehicle power units.

U.S. Pat. No. 3,501,039 discloses a container handling and transporting vehicle.

U.S. Pat. No. 3,550,713 discloses mounting end plates secured to the radiator and engine. The plates have openings that aid in the removal of the motor. There is also a lift bracket to allow the T-bar and a chain to remove the engine.

U.S. Pat. No. 3,710,885 discloses a vehicle engine mounting in which the drive connection allows movement of the engine which is mounted on a sub-frame which is swingable to a position where it is not aligned with the main chassis to provide access to both sides of the engine for serving without disconnecting the drive connection with the axle.

U.S. Pat. No. 3,783,964 discloses a vehicle with a quick-disconnect engine module so that it can be moved form a connected position to a retracted position.

U.S. Pat. No. 3,882,951 discloses a vehicle with a slidable engine mounting frame that is relatively movable with respect to the chassis frame.

U.S. Pat. No. 3,966,061 discloses an apparatus for installing and removing the drive assembly using lifting devices on a guide rail.

U.S. Pat. No. 4,231,708 discloses an arrangement for disconnecting an engine module from a vehicles using a service cart.

U.S. Pat. No. 4,276,952 discloses lifting means for moving a transmission package. The lifting means works with first and second guide means to move and remove the package. A vehicle component having first guide means that is a pair of rollers and a second guide means that comprises a pair of rails or rods.

U.S. Pat. No. 4,523,655 discloses a transmission having a transmission casing having a forward wall and a rear wall. The housing can be mounted to the housing section

U.S. Pat. No. 4,534,442 discloses a vertically installed engine low floor bus in which the engine is mounted so that the engine and transmission assembly can be mounted on a sub-frame that can pivot for downward swinging movement to a position to provide increased accessibility to the engine and transmission assembly.

U.S. Pat. No. 4,601,360 discloses a beam and chain hoist for removing a vehicle transmission.

U.S. Pat. No. 4,770,427 discloses an aircraft loader assembly.

U.S. Pat. No. 4,774,386 discloses an arrangement so that a suspension device can be placed on the frame of an automobile, for maintaining, lowering or raising the transmission or the engine for repair.

U.S. Pat. No. 4,796,721 discloses a system for displacing a power pack of a vehicle. The system has telescopic cylinders to raise the power pack. The three cylinders can be ball screw jacks.

U.S. Pat. No. 5,251,721 discloses a semi-hybrid electric automobile which is intended to permit easy conversion form electric propulsion to fuel propulsion.

U.S. Pat. No. 5,845,734 discloses a slide out engine mounting system for automotive vehicle which discloses the mounting of an engine within a chassis frame of a vehicle and which is slidably arranged to be removed.

U.S. Pat. No. 5,897,100 discloses a faceplate having a tube attached to an engine to allow the engine to be moved by a crane.

U.S. Pat. No. 6,050,358 discloses a dual pivot swing-out engine tray which permits rotation of the engine outward and out of the engine compartment so that items on the back side of the engine can be accessed.

U.S. Pat. No. 6,270,051 discloses a drive train mount adapter plate and pivot bracket for pivotally securing an isolating mount to a drive train component.

U.S. Pat. No. 6,435,360 discloses a vehicle supported lift system for installing and removing motor vehicle parts and which is adjustable to fit in the engine compartment of a vehicle.

U.S. Pat. No. 6,511,059 discloses an antivibration device and mechanical assembly including such a device.

U.S. Pat. No. 6,802,498 discloses an engine mount having a bracket with an arm portion that has a plate with an opening welded thereto and a mount.

U.S. published patent application 2004/0041134 discloses an engine removal/replacement apparatus using an adaptor arm.

Foreign publication GB 2019330 A discloses a vehicle having en engine and a transmission unit supported on a frame which can slide backwards and forwards to allow access to the engine and transmission unit.

Foreign publication JP 07308050 A discloses an elevator motor mounting and dismounting arrangement with a left to lift a housing support and an auxiliary elevator at one end of the support to lift the free end of a motor housing.

### SUMMARY OF THE PRESENT INVENTION

The engine mount of the present invention works in conjunction with the other components of this engine and transmission removal solution as a functional and integral piece to decrease overall removal time of the engine and transmission unit. The primary problem is that current engine mounts cannot be bolted or pinned to the necessary surrounding framework of the engine and transmission to allow for replacement in less than 30 minutes. The new engine mount has provisions to allow another lifting point to be secured to the rear engine mounts, thereby tying the entire framework together in a unified structure.

The new engine mount can be a milled piece of steel, or other material with suitable strength and other characteristics, with a welded flange, (which may also be attached by other suitable means) for strength as well as to provide a mating surface for the surrounding engine framework. There can be holes drilled to accept the engine block as well as a vertical hole for the mounting hardware to the frame itself. Other attaching methods will be known to those skilled in this art. An additional slot may be added to allow the attachment of the combination engine and transmission hoist mount. While the mount is engaged with the frame, the hoisting mount may be removed to prevent unwanted vibrations. At the time of engine removal, the main mounting bolt is removed and the hoisting mount is attached to prepare for rapid engine and transmission removal.

The engine mount of the present invention is designed for rapid engine and transmission removal. This invention provides an engine mount with additional framework around the engine. This framework is important when removing the engine rapidly once all hose connections are broken and mounting points released. This engine mount also has a “hard stop” designed into it to indicate to the maintainer that the engine is properly located longitudinally and is ready to be fastened and thus acts as a locator.

This engine mount can be a combination engine and transmission mount and provides a more centralized lifting point that ties the rear engine mounts together to create a unified structural framework to allow for a safe and controlled replacement of the engine and transmission assembly quickly, for example in under 30 minutes.

With this combination mount a maintainer can execute a replacement in less than 30 minutes because of the increased stability and strength offered by the hoist point. This combination ties the rear engine hoist to the current rear engine hoist position to provide a structurally superior lifting point. This more centrally locates the center of gravity of the engine/transmission assembly between the front engine hoist and the new combination hoist. It is not a permanent fixture of the engine and can be removed from the rear engine mounts for engine service.

The engine framework provides a surrounding structure to the engine and transmission that allows the removal of the engine and transmission unit in less than 30 minutes. It ties the front and rear mounts into a unified structure in addition to establishing a basis for the addition of other components such as rollers, slides, and additional mounts that will all contribute to reducing the removal time.

In one embodiment there is a combination of a C-channel, rollers, the rear engine mounts, and an alternative front engine mounting solution into one welded assembly, a robust structure is formed that will accomplish two main goals. First is to create a structure capable of holding the combined weight for the engine and transmission as a unit. The second goal is to provide attachment points for rollers, allowing said removal of the engine and transmission framework

This provides for the removal of the engine and transmission as a combined unit over the conventional method of removal. Each component does not need to be removed individually which increases overall removal time. The number of steps to remove both units is reduced if they are removed simultaneously, thereby decreasing removal time for the maintainer. Also, the rollers as part of the framework, located the engine and transmission into the bay allowing for simpler installation and extraction further reducing maintenance time.

The framework ties the front and rear engine mounts together into a unified structure. With such a robust framework, both the engine and transmission can be safely supported during extraction or replacement. The rollers of the framework also provide a guided path during vehicle maintenance for a safe and controlled operation.

The lift mechanism works in conjunction with the other components as a functional and integral piece to decrease overall removal time. This lift mechanism allows the engine and transmission to be lifted off of its mounts and permits the pair to be extracted from or replaced in the vehicle cleanly.

This allows the maintenance technician to easily extract and replace the engine-transmission assembly in less than 30 minutes. The lifting mechanism provides a way for the assembly to be lifted from its hard-stop mounting location for extraction. Once a hoist is taut, the rails of the lift mechanism provides a guide path for the engine and transmission as it exits the vehicle. During replacement, the rails also will guide and assembly back against the hard-stops and into the correct position for mounting. When in place, the lift mechanism is disengaged and the mounts will seat fully on the frame.

It eliminates the time needed to position the engine and transmission on its mounts within the frame. Lateral positioning of the engine and transmission is governed by the rollers on the lifting mechanism's rails.

The lifting mechanism allows for the engine/transmission to be lifted from its hard stop mounting location for extraction. Rails of mechanism provide a safe guide path into and out of the engine compartment. Rails swing away when not in use, allowing engine to seat fully on frame. Pins can be inserted into pivoting arm to keep rails in position both when in-use and when stored away.

A safe way to get the engine/transmission off of their hard=mounts to be able to access lifting points by hoist. Once hanging, there was no means to extract the assembly rapidly without causing risk of damage to assembly or surrounding components.

A pivoting lifting mechanism provides a simple way to lift the assembly off of the chassis mounts. Support assembly while attaching hoist provide a guide during assembly extraction or insertion. Inserting a pin into pivoting arm keep rails in place during operations. The mechanism quickly and safely gets engine assembly into a removal position. The rails guide the assembly into and out of the vehicle. Pinning the pivoting arms keeps the rails in place. Guiding assembly limits damage to vehicle components by eliminating collisions.

A manual actuator provides a means for raising and lowering the supporting rails and framework of the lift mechanism by hand operated tools already in use. The manual actuator functions as an integral piece of the arrangement for rapid removal of engine and transmission unit quickly. There is a need to raise the engine off the engine mounting pads before rolling the unit from within the framework. This manual-actuator serves as the interface between the surrounding engine framework and the operator/maintainer.

Once the range of motion of the lifting mechanism is defined, the manual actuator is constructed, which, in one embodiment, uses a captive pivoting threaded ring and an oversized unthreaded receptacle that is bolted to the linkage arm of the lifting mechanism. A bolt is then threaded through the captive pivoting ring providing a constant engagement of the lifting mechanism to the grounded frame. The maintainer then uses a simple tool, such as a ratchet wrench and socket to raise and lower the engine and transmission assembly from the engine mounts.

It can be constructed so that it requires no electricity, hydraulic power or gears which is important because engine removal for tactical vehicles of this type sometimes must be performed in the field where various types of auxiliary power are not readily available.

A moving device should be used which offers a high mechanical advantage to other mechanical means of lifting, which provide for any operator of any size and physical strength will be able to use the manual actuator. It also offers a high degree of safety. Such a device should provide the benefit of an inherently high mechanical advantage and when loaded will not release or loosen due to the friction of the threads. In a preferred embodiment such a moving device is a screw-type. The manual actuator in a preferred embodiment is constantly loaded throughout its range of motion so the device cannot accidentally release. It can be used with a simple hand tool. With this device an operator can lift the entire engine and transmission using only hand tools driving to decrease the repair time to the target range to 30 minutes.

In one embodiment of the invention, using five components, a system is provided which enables the rapid engine/transmission assembly removal in a vehicle. This engine mount can replace a standard mount and it still secures the engine to a chassis, but acts as a mounting location for the combination engine/transmission hoist mount during engine removal and acts as a “hard-stop” for engine location during engine replacement.

The present invention together with the above and other advantages may best be understood from the following detailed description of the embodiments of the invention illustrated in the drawings, wherein:

### BRIEF DESCRIPTION OF THE DRAWINGS

FIG. 1 is an isometric diagrammatic view of a vehicle engine with an engine mount, as part of a lift assembly, connected and showing the engine mount attached to an engine.

FIG. 2 is an isometric diagrammatic view of the engine mount.

FIG. 3 is an isometric diagrammatic view of the lift assembly.

FIG. 4 is an isometric diagrammatic view of the engine and lift assembly, including the rail inside of the vehicle.

FIG. 5 is a side view of the engine and lift assembly showing it in its retracted position.

FIG. 6 is a side view of the engine and lift assembly showing it in its extended position.

FIG. 7 is a side view showing part of the vehicle chassis with the lift mechanism attached.

FIG. 8 is a side view of the engine and lift assembly showing it in position where it has been rolled out of the vehicle.

FIG. 9 is an isometric view of the engine and lift assembly so the parts are shown from a different position.

FIG. 10 is an isometric view of one of the pair of members of the lift mechanism.

FIG. 11 is an isometric view of the hoist mount.

FIG. 12 is an isometric view of a manual actuator for the lift mechanism shown in its elevated position.

FIG. 13 is a side view of a manual actuator shown in its collapsed position.

FIG. 14 is a side view of a manual actuator shown in its elevated position.

FIG. 15 is a side view showing the different centers of gravity.

FIG. 16 is an isometric diagrammatic view of the assembly with the bumper of the vehicle folded down, and the radiator removed.

### DETAILED DESCRIPTION OF PREFERRED EMBODIMENTS

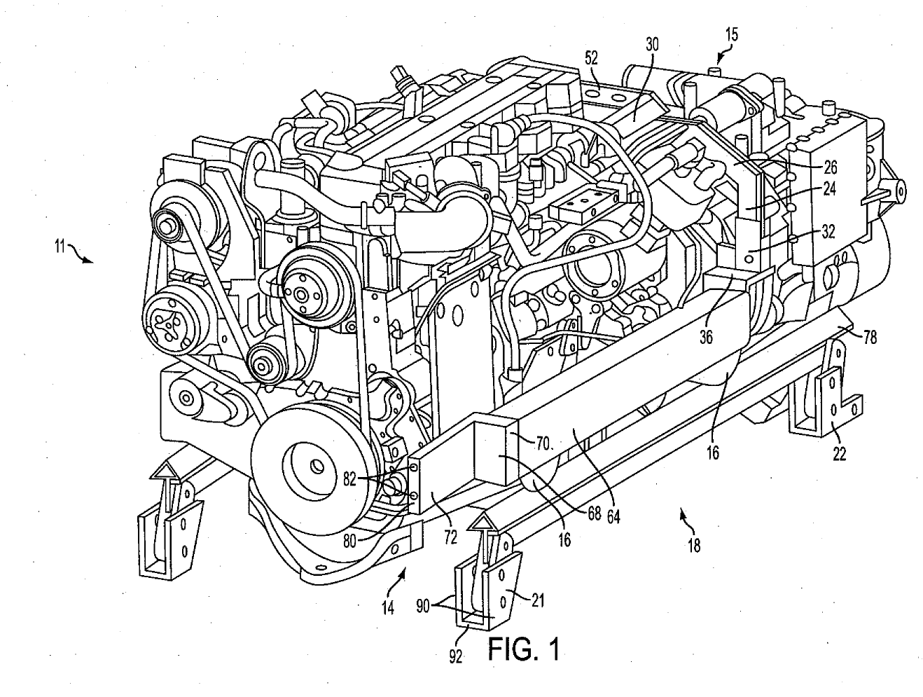

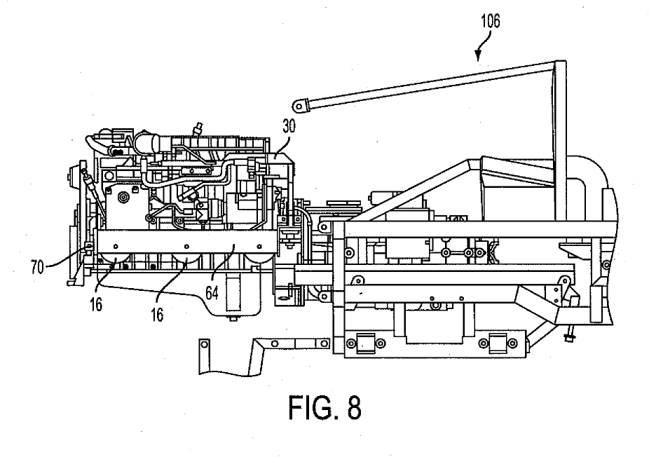

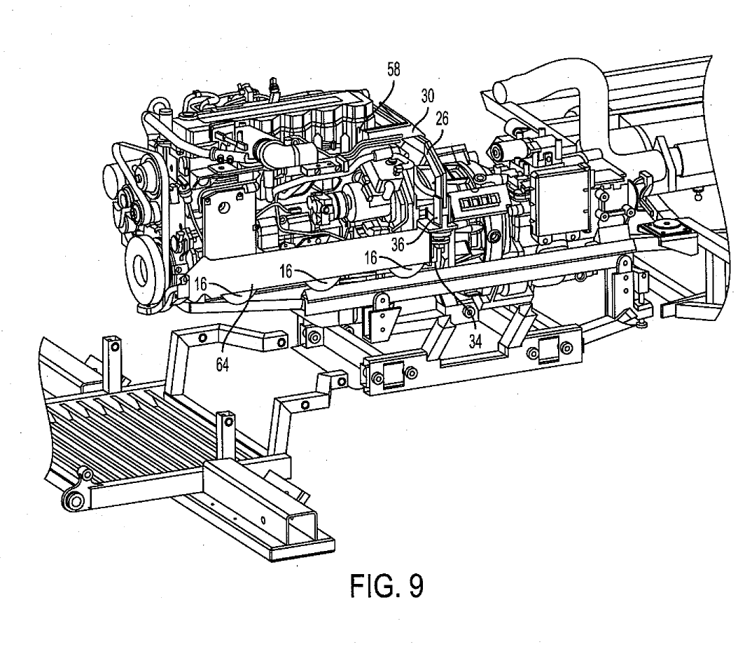

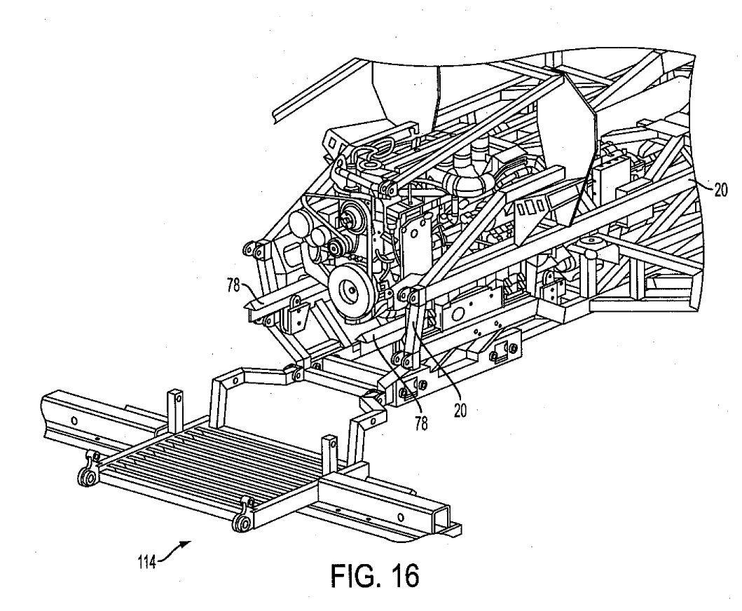

FIGS. 1, 8, 9 and 16 show the engine 11 and transmission 15 together with the engine and lift assembly of the present invention in a position prior to being removed (FIGS. 1 and 16) and then in a position while it is being removed (FIG. 9), and in its position after it has been removed (FIG. 8). The assembly is removed by moving it to the left as shown in these figures so the rollers 16 may roll along the rails 78. The assembly of the present invention is shown attached to the engine in FIG. 16 (in which the front grill 116 has been pivoted out of the way) and partly detached from the assembly in FIG. 9 so that there can be movement of the engine out of the vehicle. A hoist 106 (FIG. 8) may be used in removing the engine and transmission. The various parts that together form the entire assembly will now be described.

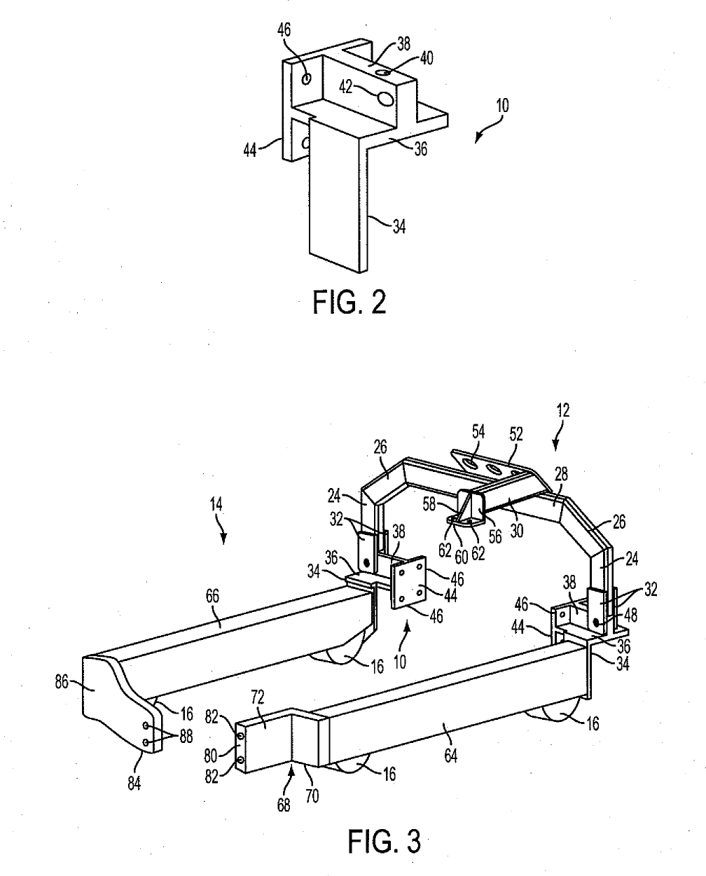

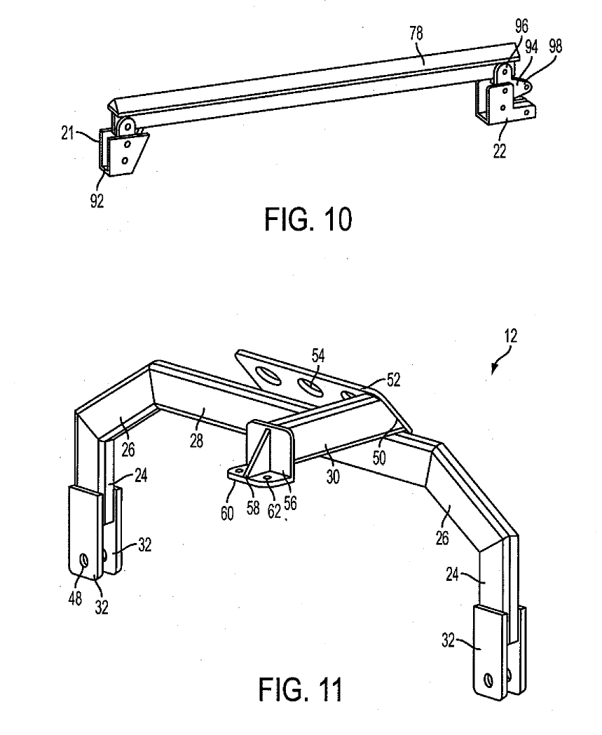

In one embodiment of the use of the present invention, there is a five component system is provided, which enables the rapid engine/transmission assembly removal in a vehicle. There is an engine mount 10 (FIG. 2) which can replace a standard engine mount and it still secures the engine to a chassis and acts as a mounting location for the combination engine/transmission hoist mount 12 (FIGS. 3 and 11) during engine removal and acts as a “hard-stop” for engine location during engine replacement. In addition to the hoist mount 12 there is an engine framework 14 (FIG. 11), a lift mechanism 18 (FIG. 1) and front and rear mounts 21 and 22 used in conjunction with and as a part of the lift mechanism (See FIGS. 10 and 12-14). One example of this is shown in FIG. 1.

The engine mount 10 works in conjunction with other components of an engine and transmission removal hoist mount 12 (also see FIGS. 3 and 11) of which it forms a part. The engine mount 10 is attached to the engine and is used to attach the hoist mount 12 to the engine so that when the hoist mount 12 is raised, the engine is also raised. The engine framework 14 is attached to the new rear engine mount 10 and is also attached to the front of the engine to provide full support for the engine. The framework 14 has wheels or rollers 16 which roll along the top of the lift mechanism 18 when the engine is being removed.

It is to be understood that while the components are described as being used together, each of them may be used separately from the others, and also may be used in any combination of the five components.

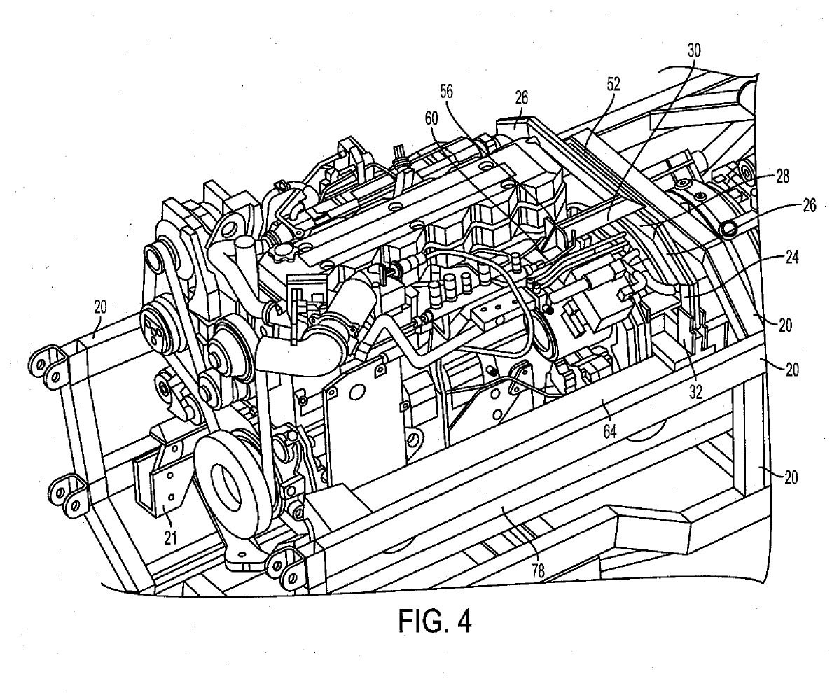

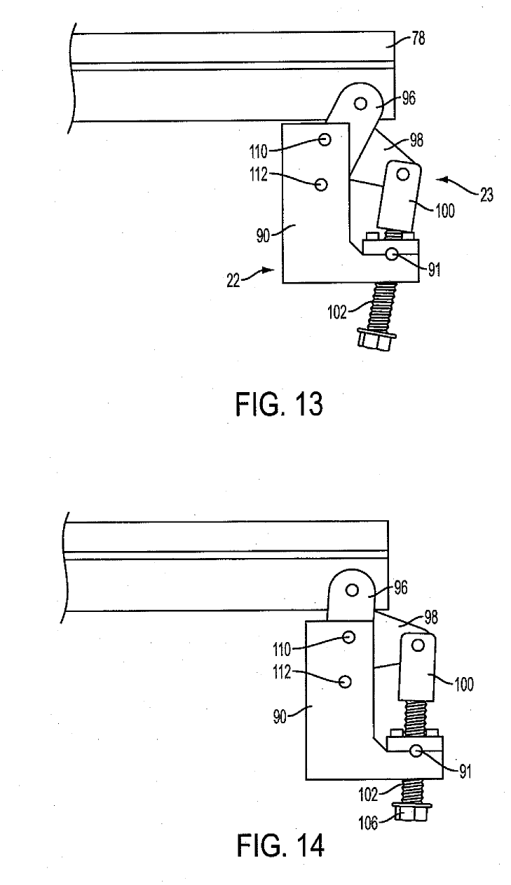

The mounts 21 and 22 of the lift mechanism 18 are attached to the vehicle chassis 20 (FIG. 4) and do not move forward and backward, but can move up and down as described below. They are fixed so the framework wheels 16 can roll along the top of the lift mechanism 18, which acts as a rail for the wheels when the engine is being removed or reinstalled. The framework wheels 16 cannot roll on the top of the lift mechanism 18 when the engine is in its operating position within the vehicle since the various parts are fixed in place to the chassis 20 and to each other, as will become clear. However, the lift mechanism 18 does have limited up and down movement which is provided by its manual actuators 23 (FIGS. 13-14) which form a part of the rear mount 22. When the engine is to be removed, the appropriate bolts and other attachment means are removed or released and the manual actuators 23 are used to lift the entire hoist assembly vertically, disengaging the engine 10 from its chassis mounts. When the arms of the lift mechanism 18 are vertical, they can be pinned to block its movement forward even when the attachment means have been released, this being done as a safety feature.

Now that the general function of the invention has been provided, the various parts will be described in more detail.

Current engine mounts of this type cannot be bolted or pinned to the necessary surrounding framework of the engine and transmission to allow for replacement in a short period of time, such as in less than 30 minutes, or 60 minutes. The engine mount 10 is arrangement to allow another lifting point to be secured to the rear engine mounts, thereby tying the entire framework together in a unified structure.

In one embodiment of the invention, the engine mount 10 (FIG. 2) includes a vertical member 34 (which engages and is attached to the end of the framework 14) and a horizontal member 36 connected to it at a right angle by suitable means known in the art. The horizontal member 36 and an upstanding flange 38 having a vertical hole 40 through it which extends also through horizontal member 36 for mounting the engine mount 10 to the chassis 20. There is a slot 42 formed through flange 38 to allow the attachment of the combination engine and transmission hoist mount 12. A mounting plate 44 is attached to the back of the horizontal member 36 and the flange 38. This plate has holes 46 for securing the engine mount 10 to a suitable location on the engine, as shown, for examples in FIGS. 1, 3, 4, 5, 6, 8 and 9. The mount 10 can, for example, be a milled piece of steel, having additional flanges welded thereto for strength. Vertical member 34 also provides a mating surface for the surrounding engine framework. While the mount 10 is engaged with the frame, the hoisting mount may be removed to prevent unwanted vibrations. At the time of engine removal, the main mounting bolt is removed and the hoisting mount is attached to prepare for rapid engine and transmission removal. The engine mount 10 is thus mounted to and connects the engine 11, the chassis 20, the hoist mount 12 and the engine framework 14.

In one embodiment of the invention, the engine hoist mount 12 (See FIGS. 3 and 11) has vertical bars 24, inclined bars 26 joined to the tops of the vertical bars 24, a horizontal bar 28 joined between the tops of the inclined bars 26. There is a forward bar 30 which extends out from the horizontal bar 28. There are mounting plates 32 attached by suitable means to the bottom area of the vertical bars 24, there being, in this example, two mounting plates 32 at the bottom of each vertical bar 24. Each mounting plate 32 has a hole 48, the holes in the plates of each vertical bar being aligned. The forward bar has an inclined surface 50 at the end which is adjacent to the horizontal bar 28. A hoist raising plate 52 is mounted to the horizontal bar 28 and to the inclined surface 50 of the forward bar. There are holes 54 in the hoist raising plate 52. A plate 56 is attached to the extended end of the forward bar 30, and a horizontal mounting plate 60 is attached to the forward bar plate 56. A reinforcing flange 58 is attached to the forward bar plate 56 and the mounting plate 60. The mounting plate 60 is provided with holes 62.

In one embodiment of the invention, the engine framework 14 (FIGS. 1, 3 and 9), which connects the front and rear engine mounts includes two longitudinal beams 64 and 66 which are attached at their back ends to the vertical members 34 of engine mounts 10 and at the front are directly connected to the engine 11. The beam 64 has an L shaped member 68 at the front one leg 70 being attached to the front of the beam and the other leg 72 being directly attached to the engine. The front 80 of leg 72 has holes 82 for mounting to the engine 11. As can be seen in FIG. 1, for example, the leg 72 is connected to engine 11 by using the existing front engine mount attachment points. The other beam 66 has a leg 84 which extends inwardly toward the engine 11 and its one end 86 is connected to the front of beam 66 and the other end has holes 88 for mounting to the engine 10. The beams 64 and 66 are provided with grooved rollers or wheels 16.

In one embodiment of the invention, the lift mechanism 18 (FIG. 10—only one being shown in this figure) includes two longitudinal rails 78. The rails are attached to the vehicle chassis through means to be described below. The lower portions of the lift mechanism may be bolted or welded to the chassis.

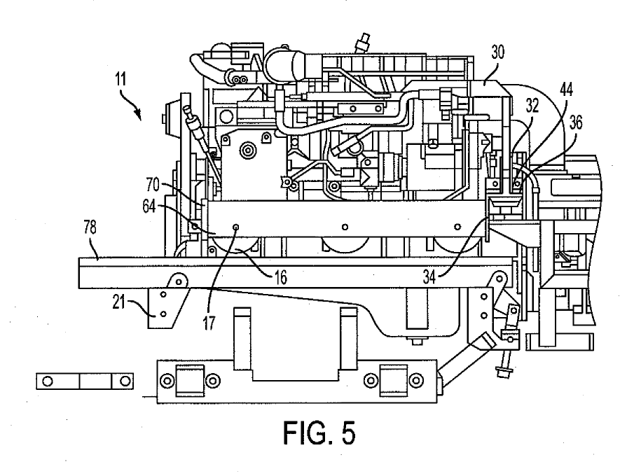

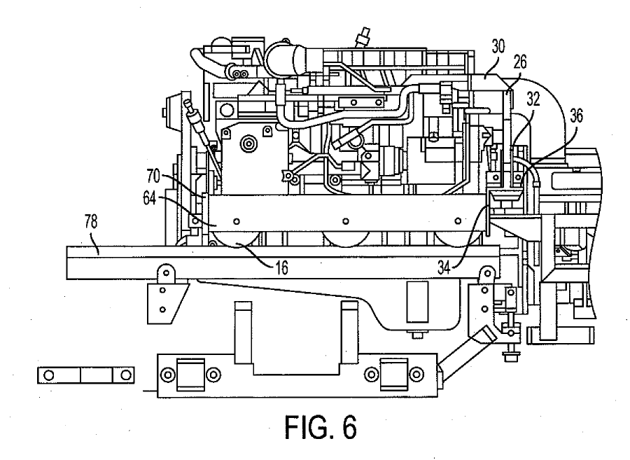

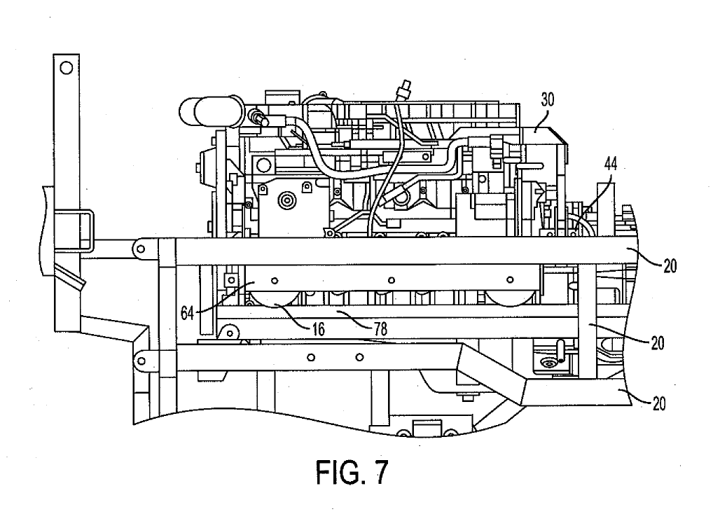

The rails are in their collapsed position when the engine is in place in the vehicle. In this position the wheels 16 are spaced above rails 78. However, when the engine is to be removed, the rails are elevated so that the grooved rollers 16 ride on them to facilitate removal of the engine 11. FIG. 5 shows the relative position of the parts when the engine is in place mounted to the chassis (collapsed position) with the wheels 16 spaced from the rails 78, and FIG. 6 shows the relative position of the parts when the engine is being removed (elevated position) with the wheels 16 resting on rails 78. It can be seen that in FIG. 5 the rollers 16 do not touch or engage the rails 78, but in FIG. 6 the rollers 16 are riding on the rails 78. The rails 78 are shown as triangular in cross sectional shape, but other arrangement may be used within the spirit of the invention. In these Figs. the wheels 16 are shown mounted to the beam by axles 17.

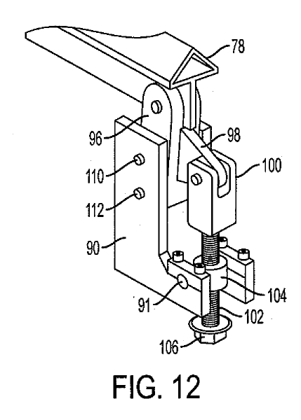

The details of the rear rail mount and actuator mechanism 22 and 23 are shown in FIGS. 12, 13 and 14. Front mount 21 is constructed in a somewhat similar manner but does not have the actuator structure. The rear mount and actuator mechanism includes two “L” shaped legs 90 which have a connector leg 92 at the bottom for holding the two legs 90 in place. This may be of a single piece or several parts connected in a suitable manner. There is a lever 94 which is pivoted to allow limited rotation. The upper lever leg 96 is connected to the nearby section of rail 78 and the side lever leg 98 extends rearwardly and is connected to the actuator fork 100. When this fork moves, the lever moves with it. A bolt 102 extends into the bottom of the fork. This bolt also extends through a nut 104 which is pivotally connected to the legs 90 by a pin 91, so that when the bolt is turned in one direction it moves within the lever leg 98 upwardly and when turned in the other direction it moves the lever leg downwardly. In this manner the mechanism is moved between its upper and lower positions. When in the upper position this action moves rails 78 into their extended position so that wheels 16 can ride on them for engine removal. Pins 110 may be used to lock the actuator mechanism against movement when in the elevated or extended position by placing them into the upper of the two holes shown in the sides of legs 90, the other hole and pin 112 providing a pivot point for the lever.

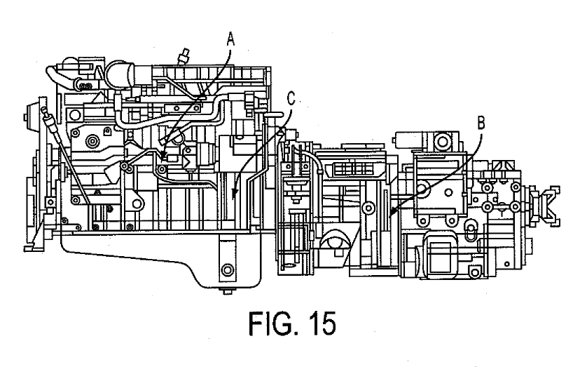

FIG. 15 shows the center of gravity of the engine at the end of the left line A, the center of gravity of the transmission at the end of right line B, and the center of gravity of the combination at the end of center line C.

FIG. 16 shows the front grill 114 in the folded down position.

The framework described here may be unique to this vehicle and specifically designed to work in conjunction with this engine configuration for this specific application.

This solution is beneficial because other engine mounts are not designed for this capability of rapid engine and transmission removal. This special application benefits from a special engine mount to be used with the additional framework around the engine. This framework is important to removing the engine rapidly once all hose connections are broken and mounting points released. This engine mount 10 also has a “hard stop” designed into it to indicate to the maintainer that the engine is located longitudinally and is ready to be fastened.

### SUMMARY OF USE OF INVENTION TO REMOVE AN ENGINE

When the present invention has been used to mount an engine and transmission, and it is desired to remove the engine and transmission, the following procedure is used:

1. The hoist is connected to the engine mount;

2. The framework, to which the engine and transmission are bolted, are unbolted from the chassis;

3. In the event pins have been used to lock the lifting mechanism, the pins are removed;

4. The lifting mechanism is actuated to provide for the assembly to be lifted from its hard-stop mounting location for extraction and when the hoist is taut that the rollers, which have been spaced above the rails, are in contact with the rails which guide the engine and transmission as it exits the vehicle;

5. During replacement the rails again guide the assembly, this time back against the hard-stops and into correct position for mounting.

6. when in place, the lift mechanism is disengaged and the mounts will seat fully on the frame.

It is to be understood that the above-described embodiments are simply illustrative of the principles of the invention. Various and other modifications and changes may be made by those skilled in the art which will embody the principles of the invention and fall within the spirit and scope of the appended claims.

1. An engine and transmission removal system comprising:
A. an engine mount for connection to an engine;
B. a hoist mount for connection to an engine and to the engine mount;
C. an engine framework for connection to an engine and to the engine mount;
D. a lift mechanism for use in removing an engine; and
E. a manual actuator for operating the lift mechanism.

2. A system as defined in claim 1 wherein said engine mount includes a structural element for attachment to a part of an engine and shaped to conform to a portion of such part and having an extension to provide an additional lifting point when removing or installing an engine in a vehicle.

3. A system as defined in claim 2 wherein said extension is constructed and arranged to provide a mating surface for the engine part.

4. A system as defined in claim 1 wherein said hoist mount surrounds at least the upper portion of an engine and is arranged to be connected thereto.

5. A system as defined in claim 4 wherein said hoist mount is constructed to surround the rear portion of an engine.

6. A system as defined in claim 1 wherein said engine framework extends forwardly of the hoist mount and has a forward end arranged to be connected to an engine.

7. A system as defined in claim 6 wherein the engine framework has wheels along its lower portion.

8. A system as defined in claim 1 wherein the lift mechanism includes a pair of rails arranged to be attached to a vehicle chassis.

9. A system as defined in claim 8 wherein the lift mechanism rails are in vertical alignment with the engine framework.

10. A system as defined in claim 7 wherein the lift mechanism includes a pair of rails arranged to be attached to a vehicle chassis, said rails being in vertical alignment with the engine framework, said lift mechanism arranged to be moved between a collapsed position in which said wheels are in contact with said rails to an elevated position in which the wheels are spaced from said rails.

11. A system as defined in claim 1 wherein said manual actuator is arranged to move the lift mechanism between an elevated position and a collapsed position.

12. A system as defined in claim 10 wherein said manual actuator moves the lift mechanism between its elevated position and its collapsed position.

13. A system as defined in claim 1 wherein said engine mount includes a structural element for attachment to a part of an engine and shaped to conform to a portion of such part and having an extension to provide an additional lifting point when removing or installing an engine in a vehicle, said extension being constructed and arranged to provide a mating surface for the engine part said hoist mount surrounding at least the upper portion of an engine and being arranged to be connected thereto, said hoist mount being constructed to surround the rear portion of an engine, said engine framework extending forwardly of the hoist mount and having a forward end arranged to be connected to an engine, said engine framework having wheels along its lower portion, the lift mechanism including a pair of rails arranged to be attached to a vehicle chassis, said rails being in vertical alignment with the engine framework, said lift mechanism arranged to be moved between a collapsed position in which said wheels are in contact with said rails to an elevated position in which the wheels are spaced from said rails, said manual actuator being arranged to move the lift mechanism between an elevated position and a collapsed position.

14. In a vehicle having an engine, a transmission, a battery, and other parts for functioning properly, the improvement comprising:
a mount for connection to a vehicle part which is to be removed from the vehicle, said mount including a structural element for attachment to the part and shaped to conform to a portion of such part which is to be removed and having an extension to provide an additional lifting point when removing or installing said part in a vehicle, said extension being constructed and arranged to provide a mating surface for the engine part.

15. The improvement as defined in claim 14, wherein the mount is constructed and arranged to provide a mounting location to act as a hard stop for engine location during engine replacement to provide an engine locator when replacing the engine in a vehicle.

16. The improvement as defined in claim 15, wherein the mount is constructed and arranged to provide the center of gravity for a combination engine and transmission mechanism which is nearer to the center of the lifting point.

17. The improvement as defined in claim 14, further comprising a hoist mount for connection to a vehicle part which is to be removed from the vehicle, said hoist mount being constructed to surround at least the upper portion of the part and being arranged to be connected thereto.

18. The improvement as defined in claim 17, further comprising an engine framework for connection to an engine and to said mount, said engine framework extending forwardly of the mount and having a forward end arranged to be connected to an engine.

19. The improvement as defined in claim 18 further comprising a lift mechanism having a pair of rails arranged to be attached to a vehicle chassis, and a manual actuator for operating the lift mechanism between a collapsed position and an elevated position, said engine framework having wheels along its lower portion arranged to ride along said rails when the manual actuator is in its elevated position.

20. The improvement as defined in claim 14 further comprising:
a hoist mount for connection to a vehicle part which is to be removed from the vehicle, said hoist mount being constructed to surround at least the upper portion of the part and being arranged to be connected thereto;
an engine framework for connection to an engine and to said mount, said engine framework extending forwardly of the mount and having a forward end arranged to be connected to an engine; and
a lift mechanism having a pair of rails arranged to be attached to a vehicle chassis, and a manual actuator for operating the lift mechanism between a collapsed position and an elevated position, said engine framework having wheels along its lower portion arranged to ride along said rails when the manual actuator is in its elevated position.

21. In a vehicle having an engine, a transmission, a battery, and other parts for functioning properly, the improvement comprising:
a hoist mount for connection to a vehicle part which is to be removed from the vehicle, said hoist mount being constructed to surround at least the upper portion of the part and being arranged to be connected thereto.

22. In a vehicle having an engine, a transmission, a battery, and other parts for functioning properly, the improvement comprising:
an engine framework for connection to an engine and to a mount said engine framework extending forwardly of such mount and having a forward end arranged to be connected to an engine.

23. In a vehicle having an engine, a transmission, a battery, and other parts for functioning properly, the improvement comprising:
a lift mechanism having a pair of rails arranged to be attached to a vehicle chassis, and a manual actuator for operating the lift mechanism between a collapsed position and an elevated position.

24. The improvement as defined in claim 23, further comprising an engine framework for connection to an engine, said engine framework having wheels along its lower portion arranged to ride along said rails when the manual actuator is in its elevated position.
